(19) United States
(12) Patent Application Publication
(10) Pub. No.: US 2002/0172442 A1
(43) Pub. Date: Nov. 21, 2002

(54) Bearing arrangement for a shaft bearing

(76) Inventors: Karl-Heinz Bade, Waldmichelbach (DE); Michael Schutz, Schliengen (DE)

Correspondence Address: KENYON & KENYON, ONE BROADWAY, NEW YORK, NY, 10004, US

(21) Appl. No.: 10/100,650

(22) Filed: Mar. 18, 2002

(30) Foreign Application Priority Data
Mar. 19, 2001 (DE) DE P 101 13 442.8

(51) Int. Cl. F16C 27/00

(52) U.S. Cl. 384/536

(57) ABSTRACT

A bearing arrangement for a shaft bearing, including a supporting ring is securable in a housing and encloses a rolling-contact bearing on the outside radially to form an annular clearance with the outer ring of the rolling-contact bearing, a bellows element which bridges the annular clearance and is attached to the supporting ring and to the outer ring and has a section with at least one fold projecting axially, a stop buffer arranged in the annular clearance outside the axial extent of the at least one fold, the stop buffer (9) being formed by a C-shaped ring (12) which is open toward the fold (2) and is secured with the supporting ring (1) or with the outer ring (6) and has a leg (13) projecting cantilevered into the annular clearance (4) to form a radial stop.

### BACKGROUND OF THE INVENTION

1. Field of the Invention

The invention relates to a bearing arrangement for a shaft bearing including a supporting ring that can be secured in a housing and surrounds a rolling-contact bearing on the outside radially to form an annular clearance with the outer ring of the rolling-contact bearing, a bellows element bridging the annular clearance and attached to the supporting ring and the outer ring, and a profile having at least one fold projecting axially and a stop buffer situated in the annular clearance outside the axial extent of the at least one fold.

### 2. Description of Related Art

A bearing arrangement of the type defined above is known from German Patent 43 17 062. With this bearing arrangement, extreme radial deflecting movements are limited by a hydraulically damping stop area. A stop buffer is situated in a liquid-filled cavity formed by a U-shaped section that is open radially, its legs being vulcanized onto a supporting ring located on the outside radially. The damping liquid is displaced with a radial yielding movement of the rolling-contact bearing. Sudden loads are reduced by a soft elastic working area, and the development of stop noises is effectively counteracted. However, it is relatively costly to manufacture this elastomer body filled with damping fluid. For certain application cases, however, the manufacturing costs are of primary concern.

### SUMMARY OF THE INVENTION

It is an object of the invention to develop a bearing arrangement which is simple and cost-effective to manufacture, and that is robust and not susceptible to faults.

These and other objects are achieved by the fact that a stop buffer is formed by a C-shaped ring which is open toward the fold and is secured with the supporting ring or with the outer ring, and it has a leg which projects like a cantilevered arm into the annular clearance formed by the outer ring of the rolling-contact bearing and by the supporting ring. This limits in a technically simple manner extreme radial deflections of the shaft arrangement to be supported with the bearings. The C-shaped ring may be attached easily by a press fit to the supporting ring or the outer ring of the rolling-contact bearing. It can be manufactured from a deep-drawable metallic material at a low cost. It is advantageous if the C-shaped ring is secured on the supporting ring and the leg can be applied to a radially adjacent section of the outer circumferential surface of the outer ring. Since only the projecting leg extends into the annular clearance, there is a spring effect on contact with the stop. To counteract undesirable acoustic stimulation of vibrations, it may be advantageous if an elastically deformable ring web onto which the leg of the C-shaped ring can be applied is vulcanized onto at least one section of this circumferential surface. It is possible to reduce stop noises in particular if the circumferential surface of this ring web has recesses, e.g., in the form of grooves or webs.

### BRIEF DESCRIPTION OF THE DRAWINGS

The present invention will be described in greater detail with reference to the following drawings wherein:

FIG. 1 shows a bearing arrangement in a cross-sectional diagram.

FIG. 2 shows a front view of the bearing arrangement in FIG. 1.

### DETAILED DESCRIPTION OF THE INVENTION

With regard to low manufacturing costs, it is advantageous if the bellows element and the ring web are formed in one piece and of a uniform material as a vulcanized elastomer part. It is especially advantageous here if the circumferential surface of the outer ring is pretreated by a chemical or mechanical surface treatment. This forms a stable rubber-metal connection between the bellows element and the outer ring of the rolling-contact bearing.

It is especially advantageous if the ring web has a first axially projecting shoulder with respect to a first end face of the rolling-contact bearing, extending axially approximately to the protruding fold, and a second shoulder of approximately the same size protruding with respect to a second end face. These two ring webs vulcanized onto the surface have their technical effect in the sense of two “gaskets.”In traditional cardan shaft bearings, these gaskets are mounted as extra sheet metal parts. Due to the fact that these ring webs are vulcanized onto the surface, this eliminates assembly and production of “extra gaskets.”

It is advantageous if the leg projecting into the annular clearance has an end piece which is folded back onto itself on the inside in the C-shaped ring. This is necessary so that no sharp edges destroy the elastomer and in order to increase the rigidity of the C-shaped ring.

For a long and robust service life of the stop buffer, it is advantageous if the leg projecting into the annular clearance is reinforced by beads in the area of the transition between its axial extent and radial extent. These reinforcing beads allow the stop buffer to absorb higher load peaks on coming in contact with the stop.

For production and installation of the bearing arrangement, it is advantageous if a second leg of the C-shaped ring surrounds the supporting ring on the circumference and if the rings are locked in position on one another by flanging. This construction involves only a few parts and is especially suitable for mass production. The stop buffer is thus permanently attached to the bellows and the rolling-contact bearing. Installation in a mounting bracket may be accomplished by a press fit in which the circumferential surface of the second leg forms a press surface.

Flanging of the supporting ring coated with elastomer results in indentations in the elastomer, joining the two rings by adhesion and bonding and thus locking them together permanently.

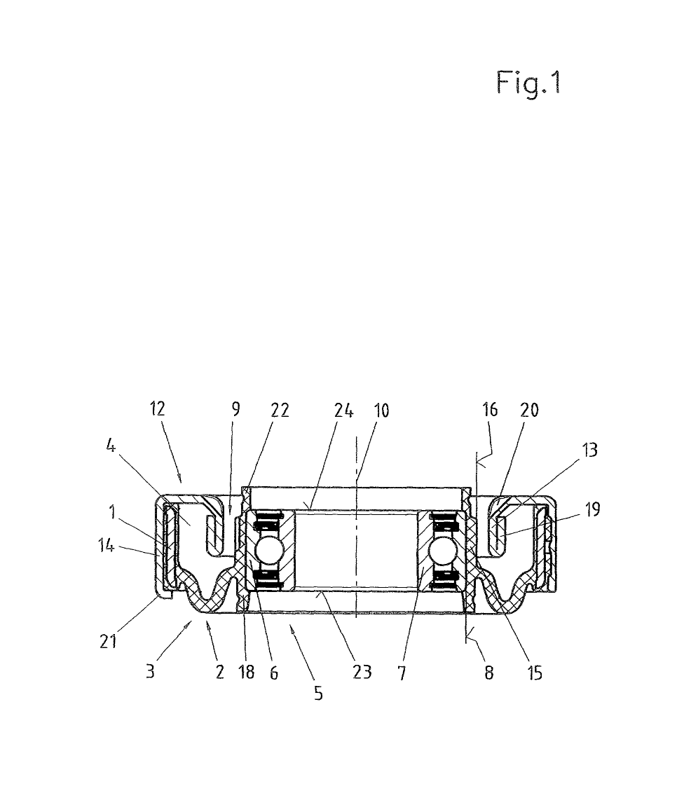

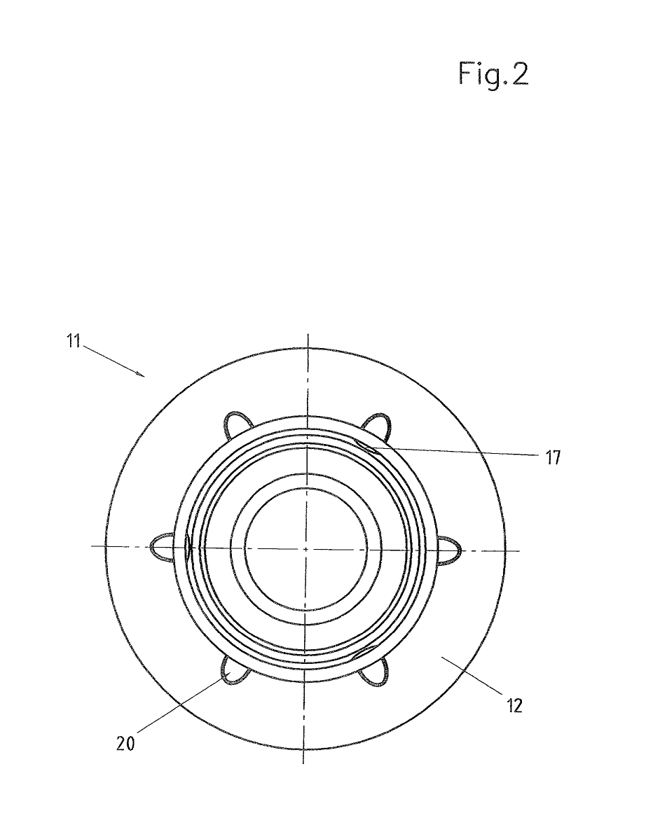

FIG. 1 and FIG. 2 show a cross-sectional view and a front view, respectively, of a preferred embodiment of the bearing arrangement according to the present invention. A bellows element 3 is attached to outer ring 6 of a rolling-contact bearing 5. Bellows element 3 bridges an annular clearance 4 formed between outer ring 6 and a supporting ring 1. In the embodiment shown here, bellows element 3 has a fold 2 projecting axially. A stop buffer 9 is situated in the annular clearance outside the axial extent of this fold 2. This stop buffer 9 is formed by a C-shaped ring 12 which is locked to supporting ring 1. One leg 13 of this C-shaped ring 12 projects like a cantilevered arm into the annular clearance, forming a radial stop there with the stop face pointing toward the rolling-contact bearing. In this stop area, a ring web 15 is vulcanized onto circumferential surface 8 of outer ring 6. Due to this rubber elastic ring web vulcanized onto the surface, noise development on stop contact with C-shaped ring 12 is reduced. Leg 13 may of course also be coated with elastomer in the stop area. As indicated clearly in the sectional diagram in FIG. 1, only leg 13 projects into the annular clearance; the radial extent of the C-shaped section is situated outside the annular clearance (in FIG. 1) above end face 24 of rolling-contact bearing 5. If stop contact occurs between circumferential surface 16 and the radially opposite stop surface of leg 13, this cantilevered leg can yield back elastically. Circumferential surface 16 of ring web 15 is provided with recesses 17. These recesses 17 receive the elastomer displaced on contact with the stop.

In the view of the bearing arrangement in FIG. 2, three recesses 17 are shown as an example. Several of these groove-like recesses 17 may of course also be situated on the circumference of ring web 15. A reinforcement of C-shaped ring 12 is achieved through beads 20 inserted in the area of the transition between the axial extent and the radial extent of leg 13 projecting into the annular clearance.

An end piece 19 of leg 13 projecting into annular clearance 4 is folded back onto itself on the inside. The 180° curve reinforces the end area of cantilevered leg 13. Ring web 15 is designed with a projecting first shoulder 18 which extends approximately to a height of fold 2 opposite first end face 23. An equally large second shoulder 22 on the opposite side of the rolling-contact bearing rises over second end face 24.

In the embodiment shown here, C-shaped ring 12 encloses supporting ring 1 with a second leg 14 on the outside radially. Flange 21 secures rings 1, 12 against one another. From the sectional diagram in FIG. 1, it can be seen that supporting ring 1 is sheathed in elastomer. Due to this rubber coating, flanges 21 are pressed into the elastomer of the coating and form a rotationally fixed, friction-type and positive locking joint.

The preferred embodiment of the present invention shown here is characterized by a design employing few parts, is robust and not susceptible to trouble in operation and can be manufactured at a comparatively low cost. The support of outer ring 6 of rolling-contact bearing 5 may of course also be formed by a bellows element 3 which is supported on the supporting ring with several folds of rubber. In another conceivable embodiment, the C-shaped ring is also attached to outer ring 6 of rolling-contact bearing 5 by a press fit with its leg situated on the inside radially, and the second leg forms a stop surface with supporting ring 1 which is situated on the outside radially.

A very permanent rubber-metal connection between bellows element 3 and ring 6 of rolling-contact bearing 5 is achieved due to the fact that circumferential surface 8 of outer ring 6 is a microscopically rough surface. Within limits, 30 support by rubber bellows 3 also allows an axial displacement of the shaft (not shown in FIG. 1 and FIG. 2) rotating about axis 10.

The present invention creates a bearing arrangement having an especially simple radial stop buffer which can be manufactured at low cost and is robust and reliable when used as intended. This bearing arrangement may be used in the drive train of a motor vehicle to support the cardan shaft, for example.

What is claimed is:

1. A bearing arrangement for a shaft bearing, comprising: a supporting ring securable in a housing which encloses a rolling-contact bearing on the outside radially to form an annular clearance with the outer ring of the rolling-contact bearing, a bellows element which bridges the annular clearance and is attached to the supporting ring and to the outer ring and has a section profile having at least one fold projecting axially, a stop buffer arranged in the annular clearance outside the axial extent of the at least one fold, wherein the stop buffer (9) is formed by a C-shaped ring (12) which is open toward the fold (2) and is secured with the supporting ring (1) or with the outer ring (6) and has a leg (13) which is cantilevered into the annular clearance (4) to form a radial stop.

2. The bearing arrangement according to claim 1, wherein the C-shaped ring (12) is secured on the supporting ring (1), and the leg (13) is applicable to a radially adjacent section of the outer circumferential surface (8) of the outer ring (6).

3. The bearing arrangement according to claim 2, wherein an elastically deformable ring web (15) is vulcanized onto at least one section of the outer circumferential surface (8) onto which the leg (13) is applicable.

4. The bearing arrangement according to claim 3, wherein recesses (17) are provided on the circumferential surface (16) of the ring web (15).

5. The bearing arrangement according to claim 3, wherein the bellows element (3) and the ring web (15) are made of an elastomer in one piece and of a uniform material as a vulcanization part.

6. The bearing arrangement according to claim 5, wherein the outer circumferential surface (8) of the outer ring (6) is pretreated by a chemical or mechanical surface treatment.

7. The bearing arrangement according to claim 3, wherein the ring web (15) has a first shoulder (18) projecting axially with respect to a first end face (23) of the rolling-contact bearing (5) and extending axially approximately to the projecting fold (2), and a second shoulder (22) of approximately the same size which projects with respect to a second end face (24).

8. The bearing arrangement according to claim 4, wherein the ring web (15) has a first shoulder (18) projecting axially with respect to a first end face (23) of the rolling-contact bearing (5) and extending axially approximately to the projecting fold (2), and a second shoulder (22) of approximately the same size which projects with respect to a second end face (24).

9. The bearing arrangement according to claim 5, wherein the ring web (15) has a first shoulder (18) projecting axially with respect to a first end face (23) of the rolling-contact bearing (5) and extending axially approximately to the projecting fold (2), and a second shoulder (22) of approximately the same size which projects with respect to a second end face (24).

10. The bearing arrangement according to claim 6, wherein the ring web (15) has a first shoulder (18) projecting axially with respect to a first end face (23) of the rolling-contact bearing (5) and extending axially approximately to the projecting fold (2), and a second shoulder (22) of approximately the same size which projects with respect to a second end face (24).

11. The bearing arrangement according to claim 1, wherein the leg (13) projecting into the annular clearance (4) has an end piece (19) which is folded back onto itself on the inside in the C-shaped ring (12).

12. The bearing arrangement according to claim 2, wherein the leg (13) projecting into the annular clearance (4) has an end piece (19) which is folded back onto itself on the inside in the C-shaped ring (12).

13. The bearing arrangement according to claim 3, wherein the leg (13) projecting into the annular clearance (4) has an end piece (19) which is folded back onto itself on the inside in the C-shaped ring (12).

14. The bearing arrangement according to claim 1, wherein the leg (13) projecting into the annular clearance (4) is reinforced by beads (20) in the area of the transition between the axial extent and the radial extent.

15. The bearing arrangement according to claim 1, wherein a second leg (14) of the C-shaped ring (12) surrounds the supporting ring (1) on the outer circumference and the rings (1, 12) are secured on one another by flanges (21).

16. The bearing arrangement according to claim 2, wherein a second leg (14) of the C-shaped ring (12) surrounds the supporting ring (1) on the outer circumference and the rings (1, 12) are secured on one another by flanges (21).

17. The bearing arrangement according to claim 3, wherein a second leg (14) of the C-shaped ring (12) surrounds the supporting ring (1) on the outer circumference and the rings (1, 12) are secured on one another by flanges (21).

18. The bearing arrangement according to claim 15, wherein the supporting ring (1) is sheathed completely in elastomer, and the flanges (21) join the rings (1, 12) by a friction-type and by a form locking joint.

19. The bearing arrangement according to claim 1, wherein at least one of the supporting ring (1) a and the C- shaped ring (12) are made of a deep-drawable metallic material.

20. The bearing arrangement according to claim 1, wherein the C-shaped ring (12) is manufactured by rolling a sheet metal ring.
